(19) United States
(12) Patent Application Publication
(10) Pub. No.: US 2018/0191984 A1
(43) Pub. Date: Jul. 5, 2018

(54) TV BOX AND TELEVISION HAVING THE SAME

(71) Applicant: Shenzhen China Star Optoelectronics Technology Co., Ltd., Shenzhen, Guangdong (CN)

(72) Inventor: Haiman SONG, Shenzhen, Guangdong (CN)

(73) Assignee: Shenzhen China Star Optoelectronics Technology Co., Ltd., Shenzhen, Guangdong (CN)

(21) Appl. No.: 15/308,346

(22) PCT Filed: Sep. 14, 2016
(86) PCT No.: PCT/CN2016/099039

§ 371 Date: Nov. 1, 2016

(30) Foreign Application Priority Data
Aug. 17, 2016 (CN) 201610685046.0

(51) Int. Cl. H04N 5/44; H04N 7/015; H04N 7/10

(52) U.S. Cl. CPC H04N 5/44; H04N 7/106; H04N 7/015

(57) ABSTRACT

The invention provides a TV box and a television including the TV box. The TV box includes a box body and a system board. The system board includes a circuit board, a TV signal processor, and a first HDMI interface. The TV signal processor and the first HDMI interface are placed on the circuit board. The TV signal processor is used for converting received TV signals to displaying data. The first HDMI interface is used for sending the displaying data to a display.

### BACKGROUND OF THE INVENTION

### 1. Field of the Invention

The present invention relates to TVs, particularly relates to a TV box and a television having the TV box.

### 2. Description of Related Art

With the development of mobile phones, the TVs (televisions) have more and more functions. The current TV includes a plurality of functional modules, such as a radio frequency module, an audio module, a system data processing module, and so on. Each module is mounted on the same circuit board to assemble a system board. The current TV mainly includes a system board and a display. The system board and the display are mounted together and are not separated randomly. It is inconvenient for users to replace the system board to update the TV.

### SUMMARY OF THE INVENTION

In order to overcome the deficiency of the related art, the purpose of the present invention is to provide a TV box and a television having the TV box.

The present invention provides a TV box. The TV box includes a box body and a system board. The system board includes a circuit board, a TV signal processor, and a first HDMI interface. The TV signal processor and the first HDMI interface are placed on the circuit board. The TV signal processor is used for converting received TV signals to displaying data. The first HDMI interface is used for sending the displaying data to a display.

As a further improvement, the system board further includes a USB interface placed on the circuit board.

As a further improvement, the system board further comprises a WIFI interface placed on the circuit board.

As a further improvement, the system board further comprises a Bluetooth module placed on the circuit board.

As a further improvement, the system board further comprises an audio interface placed on the circuit board.

As a further improvement, the system board further comprises an Ethernet interface placed on the circuit board.

As a further improvement, the system board further comprises a storage card placed on the circuit board.

As a further improvement, the storage card is an SD card.

The present invention provides a television, includes a display and a TV box. The TV box includes a box body and a system board. The system board includes a circuit board, a TV signal processor, and a first HDMI interface. The TV signal processor and the first HDMI interface are placed on the circuit board. The TV signal processor is used for converting received TV signals to displaying data. The display includes a second HDMI interface. The first HDMI interface is used for connecting to the second HDMI interface to send the displaying data to the display.

The advantageous effects of the invention are as follows. The invention provides a TV box including a box body and a system board. The HDMI interface of the system board is used for connecting to the display to send the displaying data to the display. The TV box is an individual. The TV box and the display are combined as a television. It is easy and convenient for replacement operation.

### BRIEF DESCRIPTION OF THE DRAWINGS

FIG. 1 is a block diagram of a television in accordance with the one embodiment.

FIG. 2 is a schematic view of a TV box of a television in accordance with the preferred embodiment.

FIG. 3 is a block diagram of a TV box of a television in accordance with the preferred embodiment.

FIG. 4 is a block diagram of a display of a television in accordance with the preferred embodiment.

### DETAILED DESCRIPTION OF THE PREFERRED EMBODIMENT

The following content combines with the figures and the embodiments for describing the present invention in detail. It is obvious that the following embodiments are only some embodiments of the present invention. For an ordinary person skilled in the art without any creative effort, other embodiments obtained thereby are still covered by the present invention.

It is appreciated that although terminology, such as first and second, is used to describe various elements, components, areas, layers and/or parts, these element, components, areas, layers and/or parts are not limited by the terminology. The terminology is used solely for distinguishing an element, component, area, layer or part from another element, component, area, layer or part. Thus, in the following discussion, a first element, component, area, layer or part may also be referred to as a second element, component, area, layer or part but not violating the teaching of the present invention.

Unless indicated otherwise, all the terms (include technical terms and scientific terms) used herein designate the same meaning as what generally understood by those having ordinary skills in the art. It is further appreciated that the terms that are commonly defined in dictionaries should be interoperated as including the same meaning as the contents that they posses in the related contexts and should not be interpreted in an idealized or excessively interpreted manner, unless they are clearly defined so.

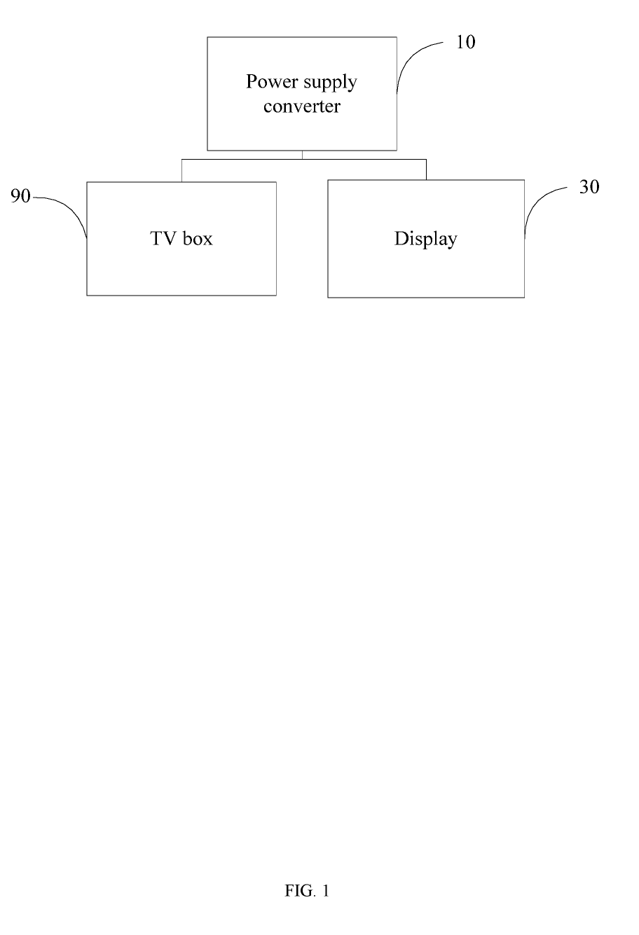

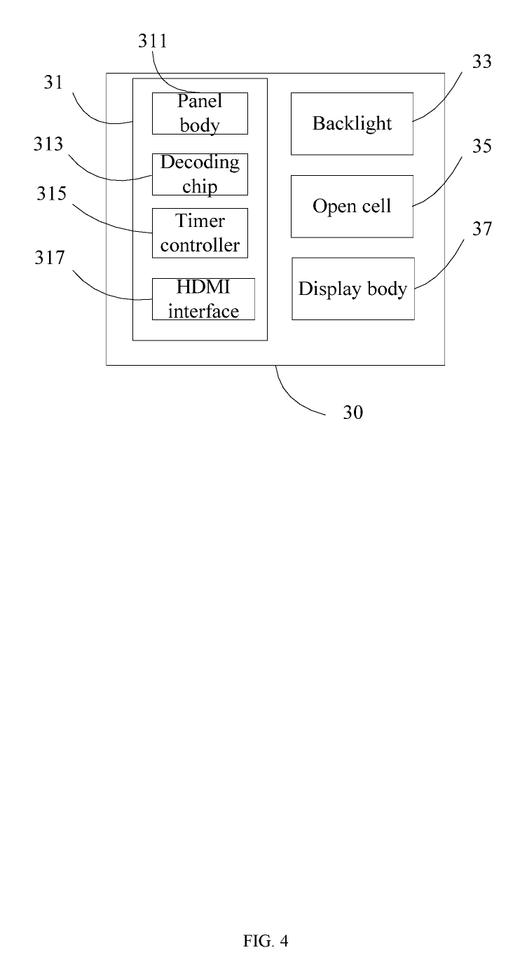

Referring to FIGS. 1 and 4, a TV in accordance with the preferred embodiment includes a power supply converter 10, a display 30, and a TV box 90. In the embodiment, the display 30 is a liquid crystal display.

The power supply converter 10 is used for converting alternating current (AC) to different direct current (DC) voltage for the display 30.

The display 30 includes a control panel 31, a backlight, and an open cell 35, and a display body 37. The control panel 31 includes a panel body 311, a decoding chip 313, a timer controller (TCON) 315, and HDMI interface 317. The decoding chip 313 is used for decoding displaying data to LVDS signals and sending the LVDS signals to the timer controller 315. The timer controller 315 sends the LVDS signals to the display body 37 to display.

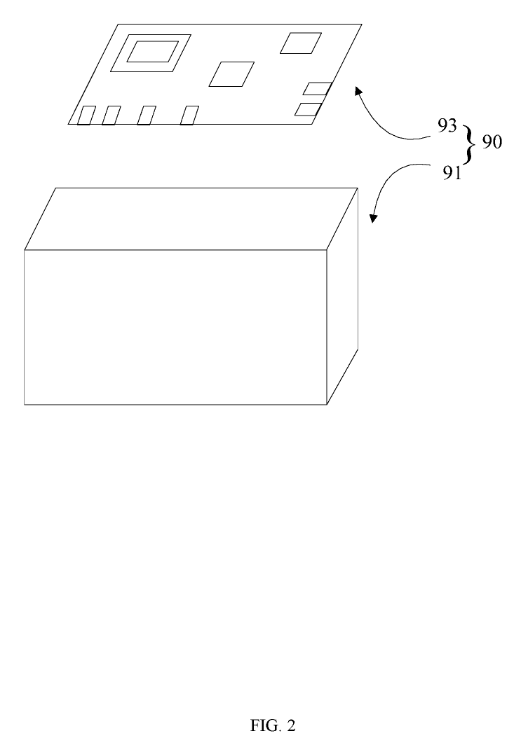

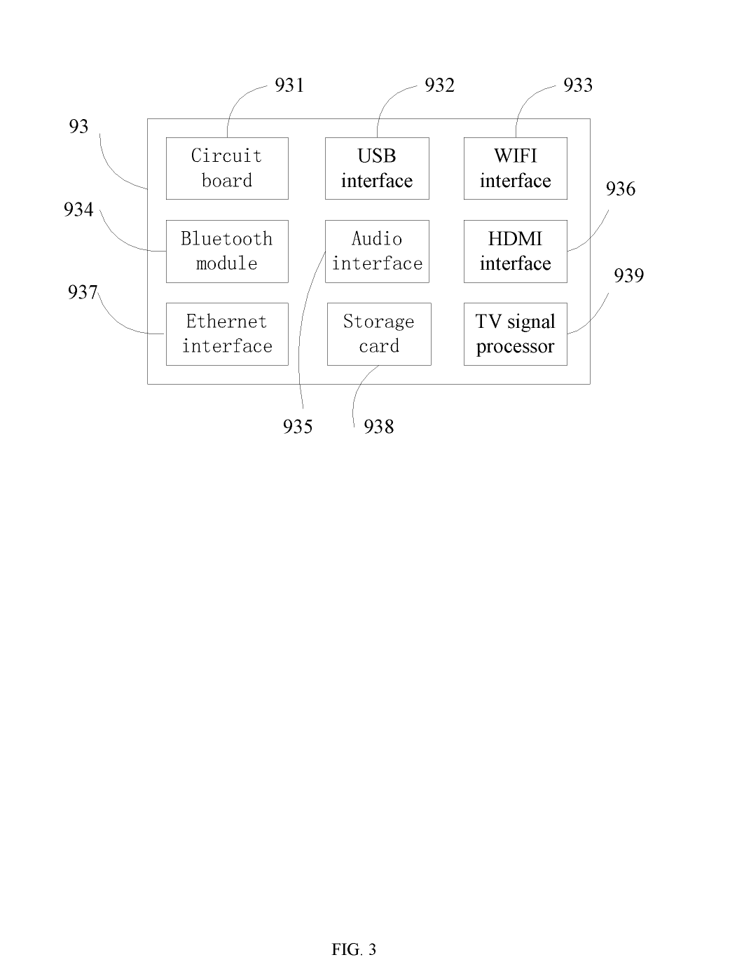

Referring to FIGS. 2 and 3, the TV box 90 includes a box body 91 and a system board 93 located in the box body 91. The system board 93 includes a circuit board 931, a USB interface 932, a WIFI interface 933, a Bluetooth module 934, an audio interface 935, a HDMI interface 936, an Ethernet interface 937, a storage card 938, and a TV signal processor 939. The USB interface 932, the WIFI interface 933, the Bluetooth module 934, and the audio interface 935, and the HDMI interface 936, the Ethernet interface 937, the storage card 938, and the TV signal processor 939 are mounted on the circuit board 931. In the embodiment, the storage card 938 is a SD card. The audio interface 935 is used for connecting to a speaker (not shown) of the TV.

The TV signal processor 939 is used for converting received TV signals to displaying data. The TV box 90 is connected to the control panel 31 of the display 30 via the HDMI interface 936 and the HDMI interface 317. The TV box 90 sends the displaying data to the control panel 31 of the display 30 via the HDMI interface 936 and the HDMI interface 317. In the embodiment, the HDMI interface 936 and the HDMI interface 317 are HDMI 2.0 model.

The TV box 90 and the display 30 are individuals and are just connected to each other via interfaces. The old TV box can be replaced with a new one when the system of the TV needs to be updated. The display 30 is directly dismounted to be replaced with a new one if the display 30 needs to be replaced, which is simple to be operated.

For a person skilled in the art, obviously, the present invention is not limited to the above exemplary embodiments disclosed herein. Besides, without deviating the spirit and the basic feature of the present invention, other specific forms can also achieve the present invention. Therefore, no matter from what point of view, the embodiments should be deemed to be exemplary, not limited. The range of the present invention is limited by the claims not by the above description. Accordingly, the embodiments are used to include all variation in the range of the claims and the equivalent requirements of the claims. It should not regard any reference signs in the claims as a limitation to the claims.

What is claimed is:

1. A TV box, comprising:
a box body; and
a system board, the system board comprising a circuit board, a TV signal processor, and a first HDMI interface; the TV signal processor and the first HDMI interface placed on the circuit board; the TV signal processor configured to convert received TV signals to displaying data; the first HDMI interface configured to send the displaying data to a display.

2. The TV box according to claim 1, wherein the system board further comprises a USB interface placed on the circuit board.

3. The TV box according to claim 1, wherein the system board further comprises a WIFI interface placed on the circuit board.

4. The TV box according to claim 1, wherein the system board further comprises a Bluetooth module placed on the circuit board.

5. The TV box according to claim 1, wherein the system board further comprises an audio interface placed on the circuit board.

6. The TV box according to claim 1, wherein the system board further comprises an Ethernet interface placed on the circuit board.

7. The TV box according to claim 1, wherein the system board further comprises a storage card placed on the circuit board.

8. The TV box according to claim 7, wherein the storage card is an SD card.

9. A television, comprising:
a display; and
a TV box, the TV box comprising:
a box body; and
a system board, the system board comprising a circuit board, a TV signal processor, and a first HDMI interface; the TV signal processor and the first HDMI interface placed on the circuit board; the TV signal processor configured to convert received TV signals to displaying data;
wherein the display comprises a second HDMI interface; the first HDMI interface configured to connect to the second HDMI interface to send the displaying data to the display.

10. The television according to claim 9, wherein the system board further comprises a USB interface placed on the circuit board.

11. The television according to claim 9, wherein the system board further comprises a WIFI interface placed on the circuit board.

12. The television according to claim 9, wherein the system board further comprises a Bluetooth module placed on the circuit board.

13. The television according to claim 9, wherein the system board further comprises an audio interface placed on the circuit board.

14. The television according to claim 9, wherein the system board further comprises an Ethernet interface placed on the circuit board.

15. The television according to claim 9, wherein the system board further comprises a storage card placed on the circuit board.

16. The television according to claim 15, wherein the storage card is an SD card.
